(19) United States
(12) Patent Application Publication
(10) Pub. No.: US 2016/0325662 A1
(43) Pub. Date: Nov. 10, 2016

(54) STEERING WHEEL WITH INTEGRAL TRAY TABLE

(71) Applicant: Steering Solutions IP Holding Corporation, Saginaw, MI (US)

(72) Inventors: Richard P. Nash, Frankenmuth, MI (US); Joen C. Bodtker, Gaines, MI (US)

(21) Appl. No.: 14/954,018

(22) Filed: Nov. 30, 2015

Related U.S. Application Data
(60) Provisional application No. 62/156,539, filed on May 4, 2015.

(51) Int. Cl. B60N 3/00; B62D 1/04

(52) U.S. Cl. CPC B60N 3/005; B62D 1/04

(57) ABSTRACT

A steering wheel configured to be rotatable and non-rotatable includes a hub, a rim disposed about the hub and connected thereto, and a tray table integral to at least a portion of the steering wheel and rotatable between a stowed position and a deployed position, the tray table rotatable about at least one hinge.

### CROSS-REFERENCE TO RELATED APPLICATIONS

This patent application claims priority to U.S. Provisional Patent Application Ser. No. 62/156,524, filed May 4, 2015, and U.S. Provisional Patent Application Ser. No. 62/156,539, filed May 4, 2015, which are incorporated herein by reference in their entireties.

### FIELD OF THE INVENTION

The following description relates to steering wheels and, more specifically, to a vehicle steering wheel with an integral tray table.

### BACKGROUND

Vehicle steering wheels are typically mounted to an end of a steering shaft connected to a steering gear and road wheels. The steering wheel enables the road wheels to turn by transmitting torque to the steering gear through the steering shaft. However, with autonomous driving assist systems, the steering wheel may not need to be manipulated by a driver. Accordingly, it is desirable to provide additional uses for a vehicle steering wheel when not in use by a passenger, operator, or driver.

### SUMMARY OF THE INVENTION

In one embodiment of the present invention, a steering wheel configured to be rotatable and non-rotatable includes a hub, a rim disposed about the hub and connected thereto, and a tray table integral to at least a portion of the steering wheel and rotatable between a stowed position and a deployed position, the tray table rotatable about at least one hinge.

In another embodiment of the present invention, a vehicle includes a steering gear and a steering wheel coupled to the steering gear and configured to be rotatable and non-rotatable. The steering wheel includes a hub, a rim disposed about the hub and connected thereto, and a tray table integral to at least a portion of the steering wheel and configured to move between a stowed position and a deployed position.

In yet another embodiment of the present invention, a steering wheel for an autonomous vehicle includes a hub, a rim disposed about the hub and connected thereto. A tray table assembly is integral to at least a portion of the steering wheel and rotatable between a stowed position and a deployed position, the tray table assembly being clear and rotatable about a plurality of axes. The steering wheel also includes a visual display integral to at least a portion of the steering wheel, the tray table assembly covering at least a portion of the visual display in the stowed position.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a steering wheel according to one embodiment of the disclosure;

FIG. 2 is a side view of the steering wheel shown in FIG. 1;

FIG. 3 is a front view of an exemplary steering wheel according to another embodiment of the disclosure;

FIG. 4 is a front view of the steering wheel shown in FIG. 3;

FIG. 5 is a front perspective view of the steering wheel shown in FIG. 4;

FIG. 6 is a rear perspective view of the steering wheel shown in FIG. 5;

FIG. 7 is a perspective view of the steering wheel according to another embodiment of the disclosure;

FIG. 8 is a tray table assembly in a stowed position;

FIG. 9 is the tray table assembly in a partially deployed position;

FIG. 10 is the tray table assembly in an at least partially deployed position;

FIG. 11 is the tray table assembly in another deployed position; and

FIG. 12 is a view of the tray table assembly employed as a keyboard.

### DETAILED DESCRIPTION

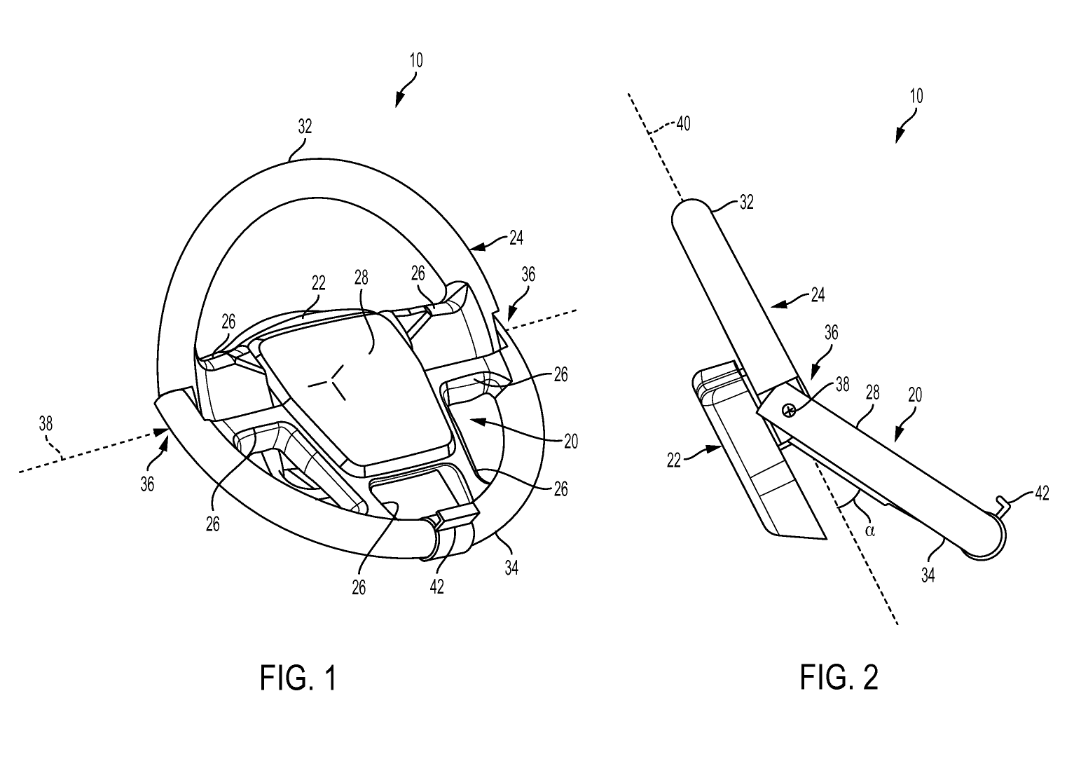

Referring now to the Figures, where the invention will be described with reference to specific embodiments, without limiting same, FIGS. 1 and 2 illustrate an exemplary vehicle steering wheel 10 that includes a stowable tray table 20 integrated therein. The tray table 20 is advantageous in a vehicle that is capable of operating in an autonomous driving mode. Autonomous driving refers to vehicles that are configured to perform operations without continuous input from a driver (e.g., steering, accelerating, braking, etc.) and may be equipped with Advanced Driver Assist Steering (ADAS) system to allow the vehicle to be autonomously controlled using sensing, steering, and/or braking technology. When the ADAS system is activated, the steering wheel is not required for vehicle control and, therefore, the vehicle provides opportunities for a driver to use the steering wheel, or accessories associated therewith, as a workspace or armrest, for example.

Steering wheel 10 generally includes a centrally located hub 22 coupled to a rim portion 24 by a plurality of spokes 26. Hub 22 includes a flat or generally flat surface 28 that provides a resting surface for an object such as a tablet, for example. Rim portion 24 includes an upper rim portion 32 and a lower rim portion 34. In the embodiment of FIGS. 1 and 2, at least one hinge 36 facilitates rotation of lower rim portion 34 about an axis 38 (FIG. 1). As such, lower rim portion 34 may be angled at an angle ‘α’ relative to a plane 40 of upper rim portion 32 (FIG. 2). In the deployed position, the lower rim portion 34 is disposed at a substantially horizontal orientation to provide a user a level surface to place an object on. It is contemplated that the lower rim portion 34 is disposed at non-horizontal orientations in the deployed position is some embodiments. Non-horizontal orientations may be desirable if a user is merely resting his/her arms on the surface 28 or if a tablet or the like is better suited at an angular orientation that is non-horizontal, for example.

Lower rim portion 34 may include a support 42 coupled thereto to support the object that is placed on surface 28. For example, support 42 may support an outer edge of a laptop (not shown).

Accordingly, lower rim portion 34 may move between a stowed position (not shown) and a deployed position (FIGS. 1 and 2). In the stowed position, lower rim portion 34 is planar to or generally planar to upper rim portion 32 along plane 40. In the deployed position, a passenger may utilize flat resting surface 28 to place an object (e.g., laptop) for use.

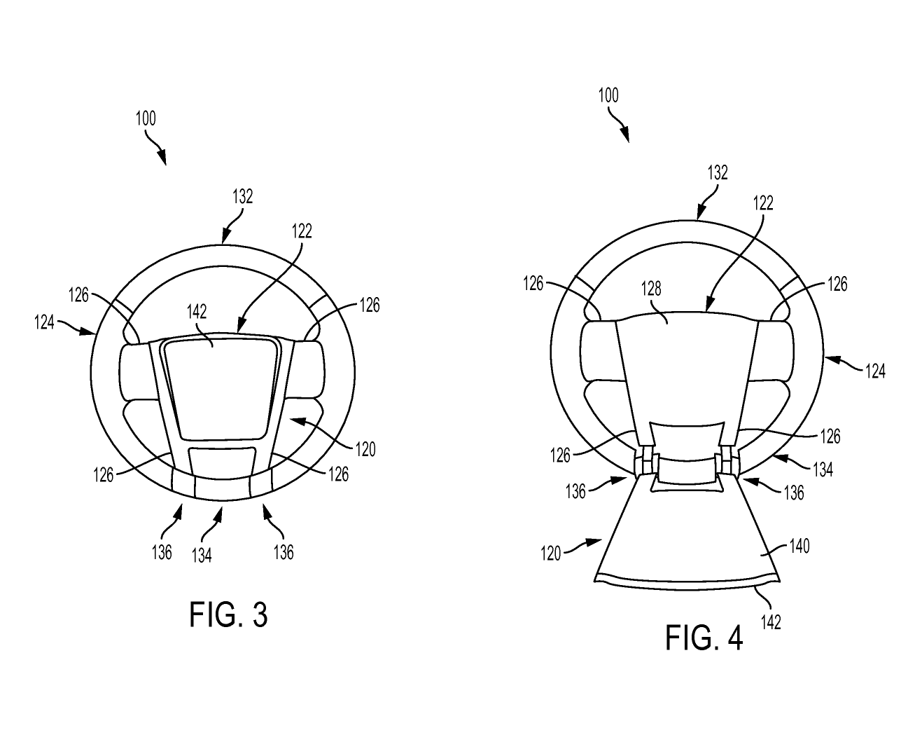

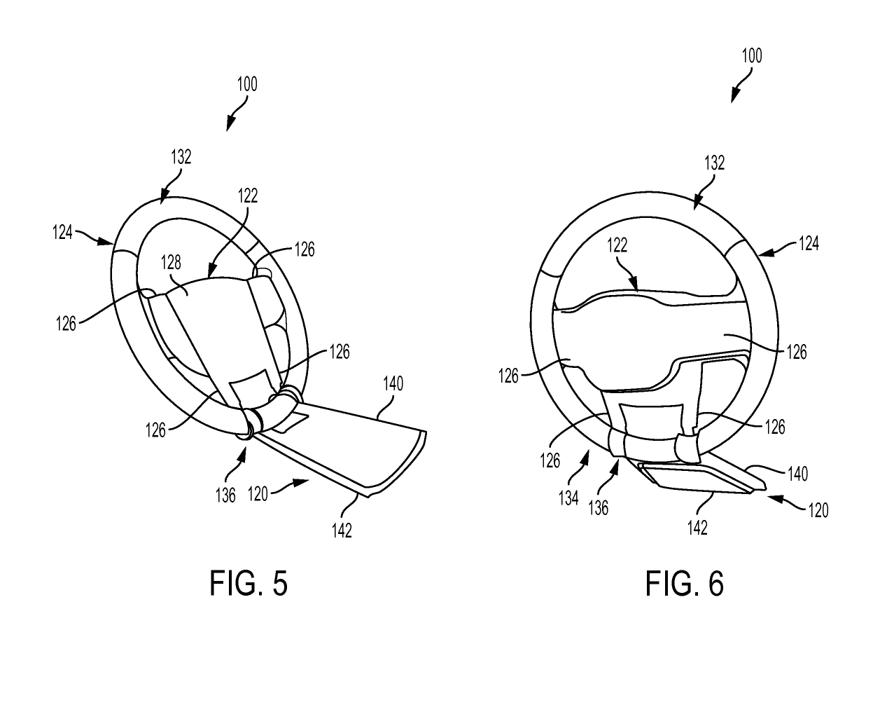

Referring now to FIGS. 3-6, illustrated is another embodiment of the disclosure, referred to as steering wheel 100 that includes a stowable tray table 120 integrated therein.

Steering wheel 100 generally includes a centrally located hub 122 coupled to a rim portion 124 by a plurality of spokes 126. Hub 122 includes a surface 128 (FIG. 4) configured to rest against or support tray table 120 when in a stowed position (FIG. 3). Rim portion 124 includes an upper rim portion 132 and a lower rim portion 134, which includes hinges 136 to facilitate rotation of tray table 120 between a stowed position (FIG. 3) and a deployed position (FIGS. 4-6).

As with tray table 20 of steering wheel 10, in the deployed position, the tray table 120 is disposed at a substantially horizontal orientation to provide a user with a level surface to place an object on. It is contemplated that the tray table 120 is disposed at non-horizontal orientations in the deployed position in some embodiments. Non-horizontal orientations may be desirable if a user is merely resting his/her arms on the surface 128 or if a tablet or the like is better suited at an angular orientation that is non-horizontal, for example.

Accordingly, tray table 120 may move between the stowed position (FIG. 3) and the deployed position (FIGS. 4-6). In the stowed position, a working surface or a first surface 140 (see FIGS. 4-6) is positioned adjacent hub surface 128, and a second, outer surface 142 (see FIG. 3) faces a passenger seated in front of steering wheel 100. In the deployed position, a passenger may utilize working surface 140 to place an object for use. For example, tray table 120 may be used to support a laptop, reading material, a tablet, food, etc.

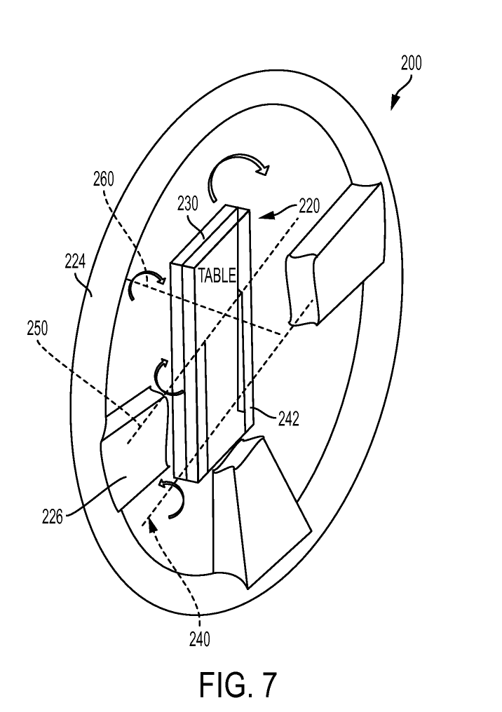

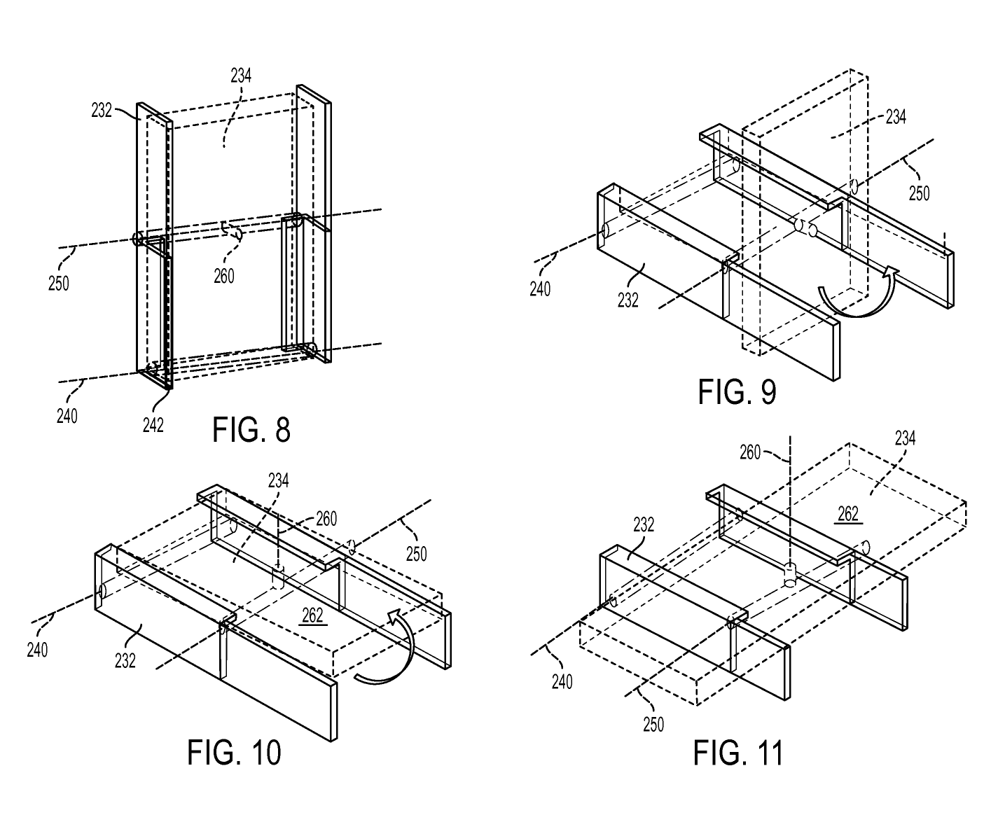

Referring now to FIG. 7, illustrated is another embodiment of the disclosure, referred to as steering wheel 200 that includes a stowable tray table assembly 220 integrated therein. The stowable tray table assembly 220 is rotatable between a stowed position (FIG. 8) and a deployed position (FIGS. 9-11). Steering wheel 200 generally includes a centrally located hub (not shown) coupled to a rim portion 224 by a plurality of spokes 226. The tray table assembly 220 is integral with the steering wheel 200 and forms at least a portion of the hub when in the stowed position.

A visual display 230 is integral with the hub, the tray table assembly 220 covering at least a portion of the visual display 230 when the tray table assembly 220 is in the stowed position. As described below, the tray table assembly 220 includes features that enhance the utility of the visual display 230 that is situated behind the tray table assembly 220 in the stowed position. The visual display 230 may be integral with the steering wheel or a component (e.g., tablet) that is stowable behind the tray table assembly 220.

Referring now to FIGS. 8-11, with continued reference to FIG. 7, the tray table assembly 220 is illustrated in greater detail. The tray table assembly 220 includes a table carriage 232 and a table plank 234. The table carriage 232 is a frame-like structure that is operatively coupled to the table plank 234 and is configured to support and transfer movement to the table plank 234.

The table plank 234 is formed of a clear material that is transparent and/or translucent. Any optically clear material may be suitable. Illustrative, but not limiting, examples of such materials include acrylic, polycarbonate and laminated glass. Such a material allows a user to view the visual display 230 even when the tray table assembly 220 is covering the visual display 230 in the stowed position.

As noted above, the tray table assembly 220 is moveable from the stowed position to the deployed position. The transition from the stowed position to the deployed position is shown sequentially in FIGS. 8-11 and described herein. In the stowed position (FIG. 8), the table carriage 232 and the table plank 234 are disposed in a substantially upright orientation that substantially corresponds to an overall plane of the steering wheel 200. Deployment of the tray table assembly 220 is initiated by rotation of the table carriage 232 about a first axis 240 located proximate a lower end 242 of the table carriage 232. Rotation about the first axis 240 moves the table carriage 232 to a substantially horizontal orientation (FIG. 9) or some other predetermined and desired angular orientation. As shown, the table plank 234 is rotatable relative to the table carriage 232 about a second axis 250 that is substantially parallel to the first axis 240. The second axis 250 is located at about a halfway point along the length of the table carriage 232 in some embodiments. The table plank 234 is rotatable about the second axis 250 to a substantially horizontal orientation (FIG. 10) or some other desired angular orientation that corresponds to the deployed position of the table carriage 232. This deployed position is referred to as a portrait orientation and may be utilized in this fully deployed position. If a user desires a landscape orientation of the table plank 234, the table plank 234 is rotatable relative to the table carriage 232 about a third axis 260 that is substantially perpendicular to the first axis 240 and the second axis 250. The fully deployed landscape orientation of the table plank 234 is illustrated in FIG. 11. In the fully deployed position (portrait or landscape), a user may rest one or more objects on a surface 262 of the table plank 234. The landscape orientation advantageously provides an orientation of the table plank 234 that resembles a keyboard, the benefits of which being described below.

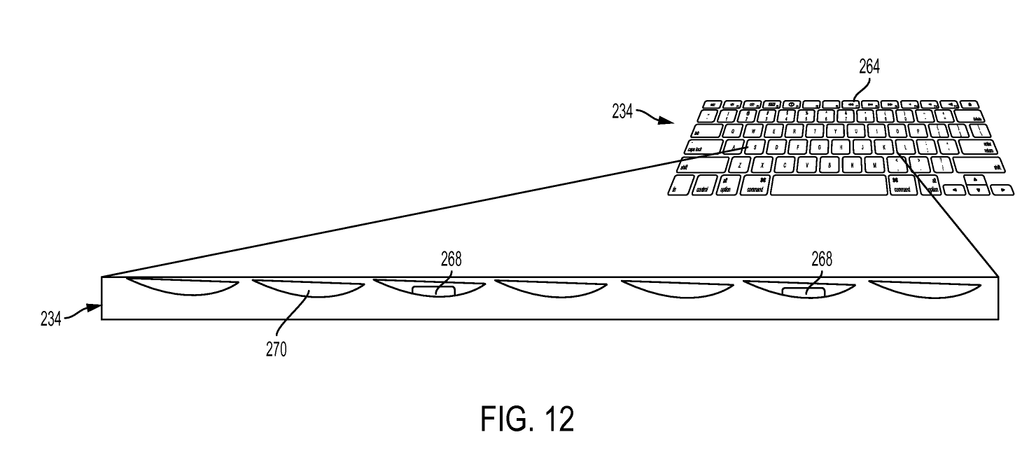

Referring now to FIG. 12, an illustrative embodiment of the table plank 234 is shown. The table plank 234 is shown in the fully deployed landscape orientation. In some embodiments, the table plank 234 is a working keyboard that may be operated in connection with the visual display 230. In some embodiments, the surface 262 of the table plank 234 has visual markings of a standard computer keyboard to assist a user with operation. In other embodiments, a visual image 264 is projected onto the surface 262 of the table plank 234 to assist a user with operation. In any of the embodiments described, the keys 270 of the keyboard may be raised or indented relative to the surface 262 of the table plank 234 to provide the tactile sensation of typical keys on a computer keyboard.

To further enhance a user's comfort with the keyboard, tactile features 268 may be included on the surface 262, the tactile features being raised or indented features that provide a “home” position for certain fingers of a user. For example, the tactile features 268 may be included in a location that corresponds to the “F” and “J” keys on the keyboard, as is standard in computer keyboards.

Advantageously, the disclosure provides steering wheels with integrated tray tables to avoid the need to stow a separate, non-integral work surface.

In some embodiments, a steering wheel is equipped with a non-rotating center hub. A light weight material is used to form a rigid, shallow, dish-shaped cover over the driver's airbag contained in the non-rotating hub. Additionally, the dish is hinged at the six o'clock position of the hub so that it can be rotated away from the hub to a horizontal fixed position in front of the driver. It is additionally understood that the dish-shaped cover of the center hub of the wheel may also have as permanent attachments, the rigid facia of the wheel spokes found at the 9 and 3 o'clock positions, making a wider surface for the tray. When not in use, the tray is rotated in the upward direction to be secured with the use of low force detents so that the driver may easily open the tray or close it. In the open position the driver is presented with a shallow, dished surface suitable to rigidly support an object such as a laptop computer or tablet that remains horizontal while the rim of the steering wheel rotates in a self-driving steering mode. The edges of the tray may be scalloped in order to assist placement of the object.

In any or all embodiments shown, the ADAS equipped vehicle employs a device so that the steering wheel rim, hub, and spokes do not rotate while in the self-driving mode. If the steering wheel is in the vehicle “straight ahead” angular position, the hinged tray may be employed to support the object.

While the tray table is not being used, it may be rotated about its hinge to the stowed position. As such, it does not impede the inflation of the driver's air bag because the hinge allows the inflating bag to rotate the tray off the hub.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering wheel configured to be rotatable and non-rotatable comprising:
a hub;
a rim disposed about the hub and connected thereto; and
a tray table integral to at least a portion of the steering wheel and rotatable between a stowed position and a deployed position, the tray table rotatable about at least one hinge.

2. The steering wheel of claim 1, wherein the at least one hinge is disposed on a lower rim portion of the rim.

3. The steering wheel of claim 1, wherein the at least one hinge comprises two hinges.

4. The steering wheel of claim 1, wherein the hub is a non-rotating center hub.

5. The steering wheel of claim 1, wherein the hub is configured to rotate.

6. The steering wheel of claim 1, wherein the rim includes an upper rim portion and a lower rim portion, the lower rim portion being at least a portion of the integral tray table.

7. The steering wheel of claim 6, wherein the at least one hinge is positioned between the upper rim portion and the lower rim portion.

8. The steering wheel of claim 7, wherein the lower rim portion is movable at an angle relative to the upper rim portion to move between the stowed position and the deployed position.

9. The steering wheel of claim 1, wherein the tray table is in a substantially horizontal orientation in the deployed position.

10. The steering wheel of claim 1, wherein the tray table is clear.

11. The steering wheel of claim 10, further comprising a visual display integral to at least a portion of the steering wheel, the tray table covering at least a portion of the visual display in the stowed position.

12. A vehicle comprising:
a steering gear; and
a steering wheel coupled to the steering gear and configured to be rotatable and non-rotatable, the steering wheel comprising:
a hub;
a rim disposed about the hub and connected thereto; and
a tray table integral to at least a portion of the steering wheel and configured to move between a stowed position and a deployed position.

13. A steering wheel for an autonomous vehicle comprising:
a hub;
a rim disposed about the hub and connected thereto;
a tray table assembly integral to at least a portion of the steering wheel and rotatable between a stowed position and a deployed position, the tray table assembly being clear and rotatable about a plurality of axes; and
a visual display integral to at least a portion of the steering wheel, the tray table assembly covering at least a portion of the visual display in the stowed position.

14. The steering wheel of claim 13, wherein the plurality of axes comprises a first axis, a second axis and a third axis, the first axis and the second axis being parallel to each other and the third axis being perpendicular to the first axis and the second axis.

15. The steering wheel of claim 14, wherein the tray table assembly comprises a table carriage and a table plank, the table carriage rotatable about the first axis to a substantially horizontal position in the deployed position, the table plank rotatable about the second axis to a position substantially parallel with the table carriage in the deployed position, the table plank further rotatable about the third axis to move between a portrait orientation and a landscape orientation.

16. The steering wheel of claim 15, further comprising a projected image of a keyboard onto the table plank when the tray table assembly is in the deployed position.

17. The steering wheel of claim 16, further comprising at least one surface feature on the projected image to locate a home position for a user.

18. The steering wheel of claim 16, wherein the keyboard receives input from a user to interact with the visual display.

19. The steering wheel of claim 14, wherein the first axis is positioned proximate a lower portion of the hub.
